(19) United States
(12) Patent Application Publication
(10) Pub. No.: US 2026/0203882 A1
(43) Pub. Date: Jul. 16, 2026

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: HISATO SEKINE, Kanagawa (JP)

(21) Appl. No.: 19/441,566

(22) Filed: Jan. 6, 2026

(30) Foreign Application Priority Data
Jan. 10, 2025 (JP) 2025-004334

(51) Int. Cl. G06T 5/92; G06T 5/94

(52) U.S. Cl. CPC G06T 5/92; G06T 5/94

(57) ABSTRACT

One or more image processing apparatuses, one or more methods, and one or more storage mediums are provided herein. One or more embodiments of an image processing apparatus comprises one or more processors that operate to determine, based on a parameter of a shooting apparatus that shot a shot image, which one of a first correction processing and a second correction processing is to be executed as a correction processing for correcting a decrease in contrast in the shot image caused by minute particles in an atmosphere, the first correction processing including performing different contrast correction for each local region of the shot image, and the second correction processing including performing contrast correction through tone curve correction, and execute the determined one of the first correction processing and the second correction processing.

### BACKGROUND

### Field of the Technology

The present disclosure relates to one or more embodiments of techniques for correcting a decrease in contrast in a shot image caused by minute particles in the atmosphere that may be used in one or more image processing apparatuses, image processing methods, and storage mediums.

### Description of the Related Art

In the field of surveillance cameras and onboard cameras, a decrease in visibility of a shot image caused by the influence of, for example, fog that exists between a camera and a subject may occur. This is because contrast in a shot image decreases as a result of scattering of light due to minute particle components in the atmosphere when the light passes through the atmosphere. In this phenomenon, the degree of scattering changes depending on the distance to the subject, and therefore in the case of a scene that includes subjects at various distances, the degree of decrease in contrast differs in different local regions of an image. As a method of correcting such a decrease in contrast, there is a method in which, under the assumption that an inappropriate black level occurs due to the influence of fog or the like, a transmittance distribution of the atmosphere is estimated from the minimum pixel values of color channels in a region (hereinafter referred to as a dark channel), and the influence of fog is removed based on an atmosphere model (hereinafter, this method will be referred to as a Dark Channel Prior (DCP) method). This makes it possible to correct a decrease in contrast that differs in different local regions.

However, in fog removal that uses the dark channel, a halo appears in the vicinity of a distance boundary, thereby causing a decrease in visibility. In view of this, a method disclosed in Japanese Patent Laid-Open No. 2020-195127 performs correction according to the DCP method at an intensity that does not cause the appearance of a halo, and then performs tone curve correction to compensate for correction insufficiency.

According to the method disclosed in Japanese Patent Laid-Open No. 2020-195127, fog removal is performed only to the extent that no halo appears. Therefore, the effect of contrast correction is lower than in the case where fog removal is applied to the fullest extent. Furthermore, in a case where both correction according to the DCP method and tone curve correction are executed, processing becomes heavy.

### SUMMARY

The present disclosure provides one or more embodiments of techniques in which correction of a decrease in contrast in a shot image caused by minute particles in the atmosphere is realized through lighter processing while also suppressing a decrease in the correction effect.

According to one or more aspects of the present disclosure, there is provided at least one embodiment of an image processing apparatus may include: one or more processors that operate to determine, based on a parameter of a shooting apparatus that shot a shot image, which one of a first correction processing and a second correction processing is to be executed as a correction processing for correcting a decrease in a contrast in the shot image caused by minute particles in an atmosphere, the first correction processing including performing different contrast correction for each local region of the shot image, and the second correction processing including performing a contrast correction through a tone curve correction; and execute the determined one of the first correction processing and the second correction processing.

According to other aspects of the present disclosure, one or more additional image processing apparatuses, one or more methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing at least one embodiment of a configuration of a system according to one or more aspects of the present disclosure.

FIG. 2 is a block diagram showing at least one embodiment of a hardware configuration of an image processing apparatus 100 according to one or more aspects of the present disclosure.

FIG. 3 is a block diagram showing at least one embodiment of a functional configuration of an image processing unit 207 according to one or more aspects of the present disclosure.

FIG. 4 is a flowchart of at least one embodiment of a processing that may be executed by the image processing apparatus 100 according to one or more aspects of the present disclosure.

FIG. 5 is a diagram showing at least one embodiment of a configuration of a table for determining contrast correction processing according to one or more aspects of the present disclosure.

FIG. 6 is a diagram for describing contrast in one or more embodiments having each of a shot image of a foggy scene, and a shot image of a scene with no fog according to one or more aspects of the present disclosure.

FIG. 7 is a diagram showing at least one embodiment of a configuration of a tone curve correction table according to one or more aspects of the present disclosure.

FIG. 8 is a block diagram showing at least one embodiment of a functional configuration of the image processing unit 207 according to one or more aspects of the present disclosure.

FIG. 9 is a flowchart of at least one embodiment of a processing that may be executed by the image processing apparatus 100 according to one or more aspects of the present disclosure.

FIG. 10A is a diagram showing at least one embodiment of a configuration of a GUI according to one or more aspects of the present disclosure.

FIG. 10B is a diagram showing at least one embodiment of a configuration of a GUI according to one or more aspects of the present disclosure.

FIG. 11 is a block diagram showing at least one embodiment of a functional configuration of the image processing unit 207 according to one or more aspects of the present disclosure.

FIG. 12 is a flowchart of at least one embodiment of a processing that may be executed by the image processing apparatus 100 according to one or more aspects of the present disclosure.

FIG. 13 is a diagram showing at least one embodiment of a configuration of a GUI according to one or more aspects of the present disclosure.

FIG. 14A is a diagram showing at least one embodiment of a configuration of a GUI according to one or more aspects of the present disclosure.

FIG. 14B is a diagram showing at least one embodiment of a configuration of a GUI according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined or changed as appropriate. Furthermore, in the attached drawings, the same reference numerals are given to the same or similar configurations, and redundant description thereof is omitted.

### Configuration(s) of One or More Embodiments

An image processing apparatus according to one or more embodiments of the present disclosure determines which one of tone curve correction and correction according to the DCP method is to be executed as correction processing for correcting a decrease in contrast in a shot image of a foggy scene (contrast correction processing), in accordance with a focal length and a distance to a focus position during the shooting of this shot image. Then, with respect to the shot image, the image processing apparatus executes one of the tone curve correction and the correction according to the DCP method that has been determined as the contrast correction processing to be executed with respect to the shot image.

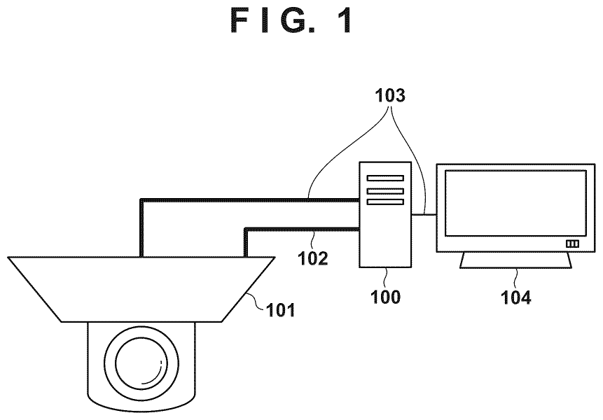

First, at least one embodiment of a configuration of a system according to one or more aspects of the present disclosure will be described using FIG. 1. As shown in FIG. 1, the system may include a camera 101 that is an example of a shooting apparatus, an image processing apparatus 100 that generates an output image by executing the contrast correction processing on an image shot by the camera 101, and a display apparatus 104 capable of displaying the output image.

The camera 101 and the image processing apparatus 100 are connected via a control cable 102, which is a Universal Serial Bus (USB) or the like. In this way, for example, the image processing apparatus 100 may control shooting by the camera 101, and obtain such parameters as shooting conditions and lens information from the camera 101.

Also, the camera 101 and the image processing apparatus 100 are connected via a video transmission cable 103, which is an Ethernet cable, a High-Definition Multimedia Interface (HDMI®) or serial digital interface (SDI) cable, or the like. In this way, for example, the image processing apparatus 100 may obtain a shot image that has been shot by the camera 101.

Furthermore, the image processing apparatus 100 and the display apparatus 104 are connected via the aforementioned video transmission cable 103. In this way, for example, the image processing apparatus 100 may output an output image generated through later-described processing to the display apparatus 104, and cause the display apparatus 104 to display the output image.

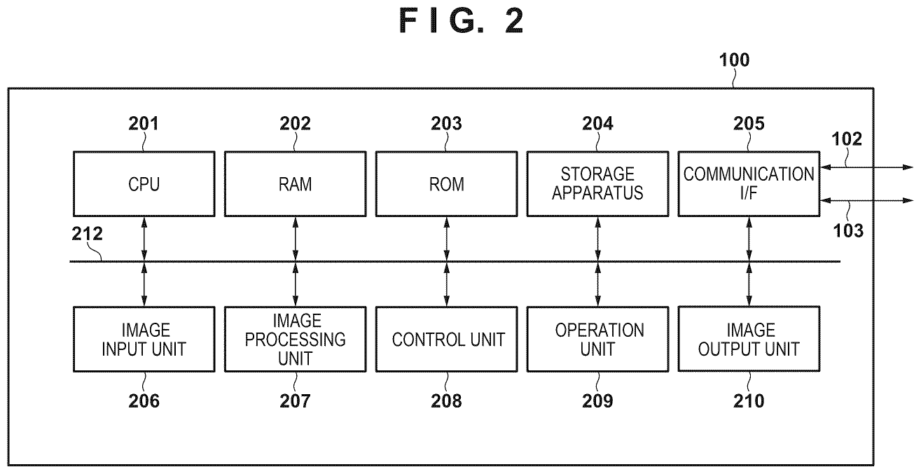

Next, at least one embodiment of a hardware configuration of the image processing apparatus 100 will be described using a block diagram of FIG. 2. For example, such computer apparatuses like a Personal Computer (PC), a smartphone, and a tablet apparatus are applicable as the image processing apparatus 100.

A Central Processing Unit (CPU) 201 executes various types of processing with use of computer programs and data stored in a Random-Access Memory (RAM) 202. In this way, the CPU 201 performs overall operational control on the image processing apparatus 100, and also executes or controls various types of processing that are described as processing executed by the image processing apparatus 100.

The RAM 202 includes an area for storing computer programs and data loaded from a Read-Only Memory (ROM) 203 and a storage apparatus 204, and an area for storing data received from the outside via a communication Interface (I/F) 205. Furthermore, the RAM 202 includes a working area that is used when the CPU 201, an image input unit 206, an image processing unit 207, a control unit 208, an image output unit 210, and the like execute various types of processing. In this way, the RAM 202 may provide various types of areas as appropriate.

The ROM 203 stores setting data of the image processing apparatus 100, a computer program and data related to activation of the image processing apparatus 100, a computer program and data related to basic operations of the image processing apparatus 100, and the like.

The storage apparatus 204 is a nonvolatile memory, such as a hard disk drive and a Solid State Drive (SSD). The storage apparatus 204 stores, for example, an Operating System (OS), computer programs and data for causing the CPU 201 to execute or control various types of processing that are described as processing executed by the image processing apparatus 100, and the like. Note that the storage apparatus 204 may be a memory apparatus that is attachable to and removable from the image processing apparatus 100, such as a USB memory and a Secure Digital (SD) card.

The communication I/F 205 is, for example, an interface like the HDMI®, SDI, and USB, and functions as an interface for data communication via the control cable 102 and the video transmission cable 103 in one or more embodiments.

The operations of the image input unit 206, image processing unit 207, control unit 208, and image output unit 210 will be described later. Although one or more embodiments will be described in relation to a case where all of the image input unit 206, image processing unit 207, control unit 208, and image output unit 210 are implemented as items of hardware, one or more of these functional units may be implemented as items of software (computer programs). In the latter case, the functions of a corresponding functional unit are realized by the CPU 201 executing such a computer program.

An operation unit 209 is a user interface like a keyboard, a mouse, a touch panel, or the like, and various types of instructions may be input to the image processing apparatus 100 through a user's operation thereon.

All of the CPU 201, RAM 202, ROM 203, storage apparatus 204, communication I/F 205, image input unit 206, image processing unit 207, control unit 208, operation unit 209, and image output unit 210 are connected to a system bus 212.

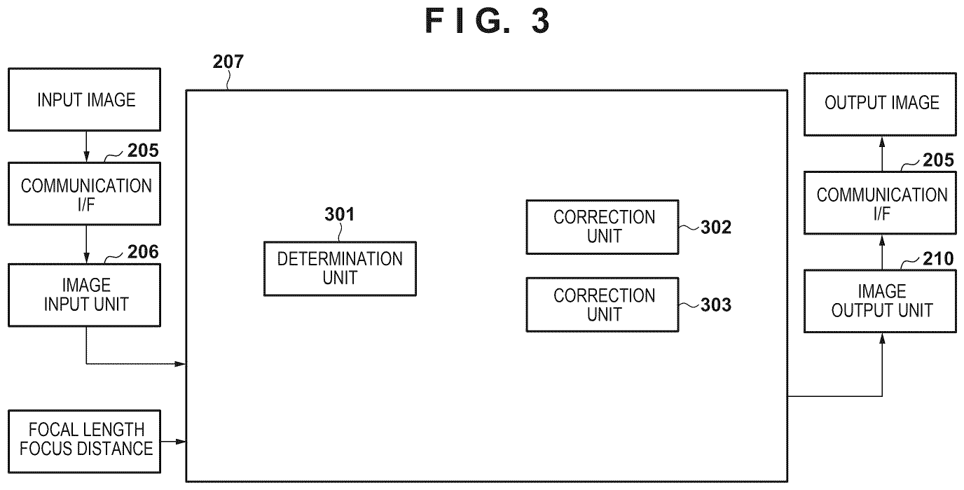

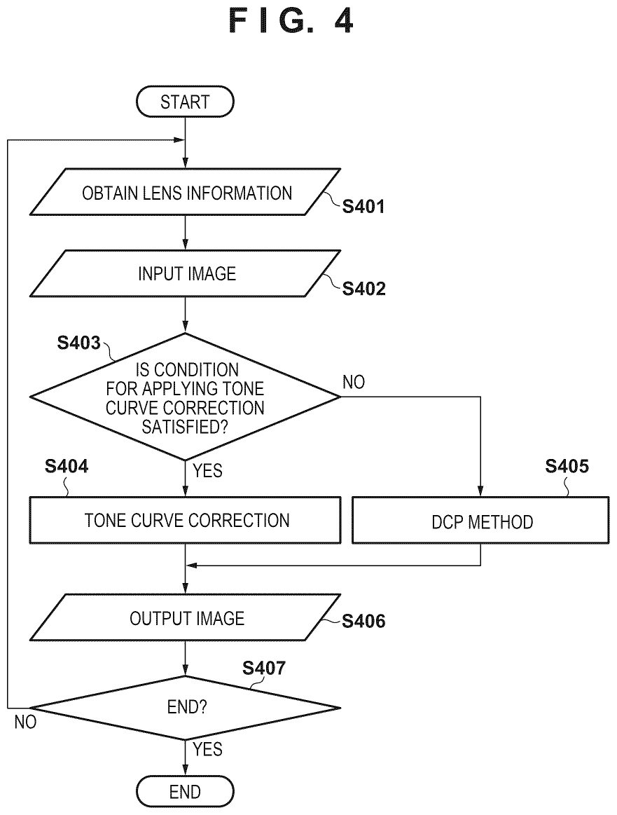

Next, processing that is executed by the image processing apparatus 100 to correct a decrease in contrast in a shot image shot by the camera 101 (a decrease in contrast in the shot image caused by minute particles in the atmosphere) and output the result of the correction will be described in accordance with at least the embodiment of a flowchart of FIG. 4. Also, at least one embodiment of a functional configuration of the image processing unit 207 is shown in a block diagram of FIG. 3.

In step S401, the image processing unit 207 obtains a focal length and a subject distance (a distance to a focus position) as lens information of the camera 101 during the shooting of an image shot by the camera 101 from the camera 101 via the communication I/F 205 and the control cable 102.

In step S402, the image input unit 206 obtains the image shot by the camera 101 as an input image I from the camera 101 via the communication I/F 205 and the control cable 102. Here, it is assumed below that I (x, y, c) denotes a pixel value (luminance value) of a color channel c at a coordinate position (x, y) in the input image I. In this case, c=R, G, B because the input image is assumed to be an RGB image as an example in one or more embodiments.

Also, the lens information obtained in the aforementioned step S401 is the lens information of the camera 101 during the shooting of the shot image obtained in step S402. Therefore, the order of execution of processing of step S401 and step S402 is not limited to the aforementioned order; steps S402 and S401 may be executed in this order, or these steps may be executed in parallel.

In step S403, based on the lens information obtained in step S401, a determination unit 301 (or one or more processors) in the image processing unit 207 determines which contrast correction processing, that is to say, which one of correction processing according to the DCP method that performs different contrast correction for each local region in the shot image, and tone curve correction processing that performs contrast correction through tone curve correction, is to be executed on the shot image obtained in step S402.

In general, in a case where a foggy scene has been shot, the degree of decrease in contrast changes depending on a distance to a subject. However, in a case where the distances to respective subjects are similar, the degrees of decrease in contrast caused by fog become constant in the shot image. That is to say, in a case where the distribution of subject distances in the shot image is not constant, the correction processing according to the DCP method is executed on the shot image, whereas in a case where the distribution of subject distances in the shot image is constant, uniform contrast correction processing like the tone curve correction is sufficient as contrast correction processing that is executed on the shot image.

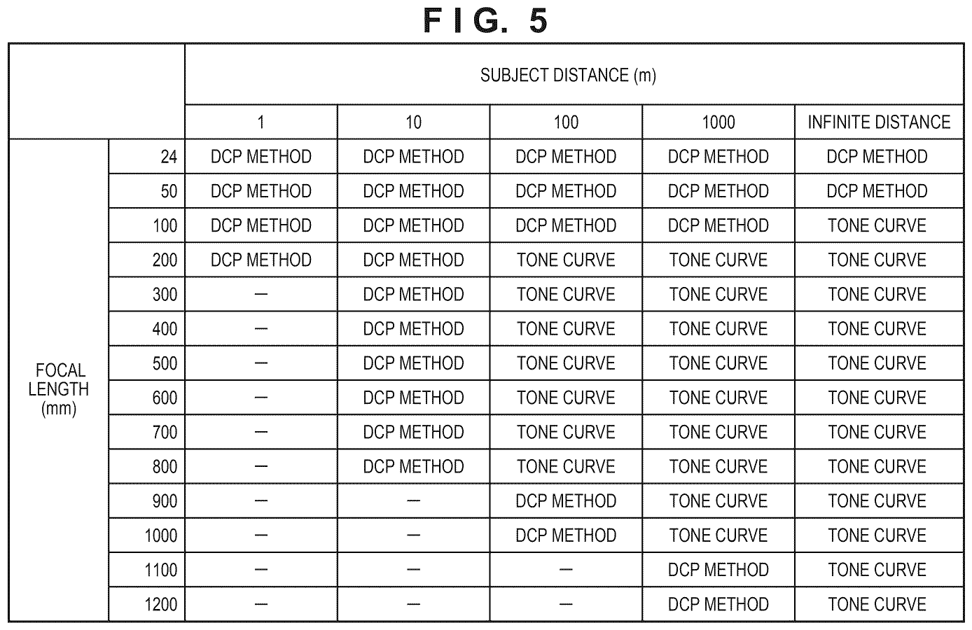

In view of this, in one or more embodiments, the determination unit 301 specifies contrast correction processing corresponding to the combination of the focal length and the subject distance that have been obtained as the lens information in step S401 with reference to a table of FIG. 5, and determines the specified contrast correction processing as contrast correction processing to be executed on the shot image obtained in step S402.

In a case where the focal length is short, the distribution of distances to subjects tends to be wide as the angle of view is wide. Furthermore, also in a case where distances to subjects are short, the distribution of distances to subjects tends to be wide. In view of this, at least the embodiment of the table of FIG. 5 is configured so that the correction processing according to the DCP method is used in the case of a lens condition with which the distribution of distances to subjects tends to be wide, and the tone curve correction processing is executed otherwise, depending on the combination of the focal length and the subject distance.

Note that a method of determining the contrast correction processing based on a focal length and a subject distance is not limited to the aforementioned method. For example, in one or more embodiments, the determination unit 301 uses a (pre-created) function indicating the relationships between focal lengths and subject distances and values indicating the distributions of distances to subjects to calculate a value indicating the distribution of distances to subjects corresponding to a focal length and a subject distance. Then, in a case where the calculated value is equal to or larger than a threshold, the determination unit 301 determines that the distribution of distances to subjects tends to be wide under the lens condition, and determines the correction processing according to the DCP method as the contrast correction processing to be executed on the shot image. On the other hand, in a case where the calculated value is smaller than the threshold, the determination unit 301 determines that the distribution of distances to subjects tends to be small under the lens condition, and determines the tone curve correction processing as the contrast correction processing to be executed on the shot image.

In a case where it has been determined in step S403 that the tone curve correction processing is to be executed on the shot image obtained in step S402, processing proceeds to step S404. On the other hand, in a case where it has been determined in step S403 that the correction processing according to the DCP method is to be executed on the shot image obtained in step S402, processing proceeds to step S405.

In step S404, a correction unit 303 in the image processing unit 207 generates an output image O by executing the tone curve correction processing on the input image I obtained in step S402. Here, it is assumed below that O (x, y, c) denotes a pixel value (luminance value) of a color channel c at a coordinate position (x, y) in the output image O.

On the other hand, in step S405, the correction unit 302 (or one or more processors) in the image processing unit 207 generates an output image O by executing the correction processing according to the DCP method on the input image I obtained in step S402.

In step S406, the image output unit 210 outputs the output image O generated in step S404 or step S405 to the display apparatus 104 via the communication I/F 205 and the video transmission cable 103.

Note that the output destination of the output image O from the image output unit 210 is not limited to the display apparatus 104. For example, the image output unit 210 may transmit the output image O to an external apparatus via a network, such as a LAN or the Internet, or may save the output image O in the storage apparatus 204.

Then, in step S407, the control unit 208 determines whether a condition for ending processing according to the flowchart of FIG. 4 has been satisfied. The ending condition is not limited to a specific condition. For example, in a case where the control unit 208 has detected inputting of an instruction for ending processing through a user's operation on the operation unit 209, the control unit 208 determines that the ending condition has been satisfied.

In a case where it has been determined that the ending condition has been satisfied as a result of this determination, processing according to the flowchart of FIG. 4 is ended. On the other hand, in a case where it has been determined that the ending condition has not been satisfied, processing proceeds to step S401.

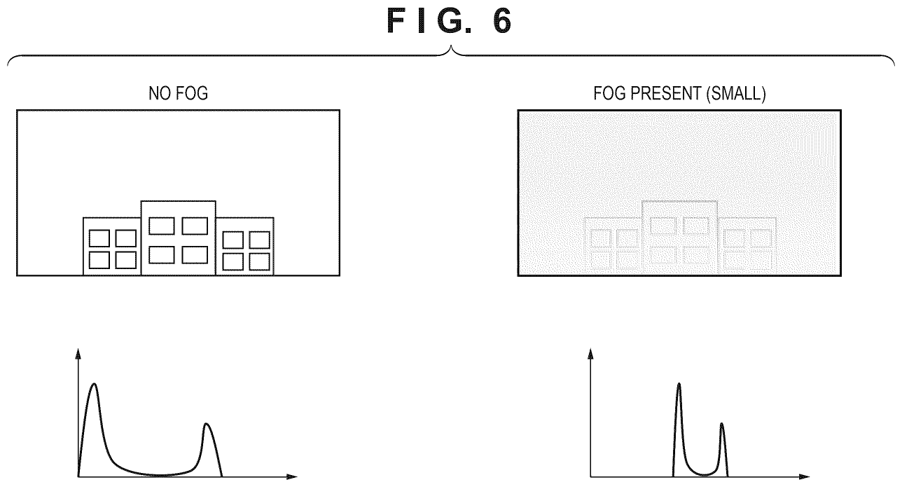

Next, an example of processing that is executed by the correction unit 303 (or one or more processors) in the aforementioned step S404 will be described. As shown in FIG. 6, in general, contrast in a shot image of a foggy scene is lower than contrast in a shot image of a scene with no fog. Therefore, in the shot image of the foggy scene, the distribution of luminance values in a luminance histogram, which is a histogram of luminance values of pixels, is concentrated in a region of a part of luminance values, and the variance of luminance values in the luminance histogram has a small value. On the other hand, in the shot image of the scene with no fog, the variance of luminance values in the luminance histogram of luminance values has a large value.

In view of this, in a case where the variance of luminance values in the luminance histogram is small, the tone curve correction is performed on the shot image so that the variance of luminance values in the luminance histogram increases; in this way, a decrease in contrast caused by fog may be corrected. The correction unit 303 generates a luminance histogram of an input image, and calculates a variance σ² of luminance values in the generated luminance histogram in accordance with the following formula (1):

$${σ}^{2} = \frac{1}{n} {\sum }_{i = 0}^{N} {( {Y}_{i} - μ )}^{2} \cdot {f}_{i} \qquad ( 1 )$$

Here, Yᵢ denotes a value of the i^{th} bin of luminance values, N denotes the total number of bins, fᵢ denotes a frequency value corresponding to the i^{th} bin of luminance values, denotes an average value of luminance values, and n denotes the total number of pixels. Note that a method of calculating the variance σ² of the luminance histogram is not limited to the aforementioned method.

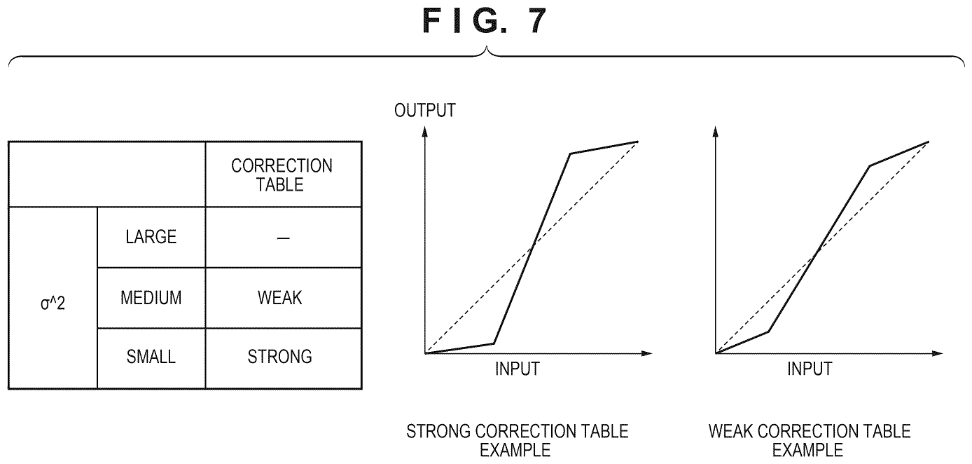

Then, in a case where the variance σ² is large (e.g., in a case where the variance σ² is equal to or larger than a threshold), the correction unit 303 does not execute the contrast correction processing on the input image because there is a high possibility that the input image is a shot image of a scene with no fog. On the other hand, as the value of the variance σ² decreases, the correction unit 303 executes the tone curve correction processing on the input image with use of tone curve correction tables with a large correction effect shown in FIG. 7.

Next, an example of processing that is executed by the correction unit 302 in the aforementioned step S405 will be described. First, the correction unit 302 generates a linear image I′ by converting the input image into a luminance-linear format, and calculates environmental light with use of the generated linear image I′. The environmental light is light components representing light which originates from the sun, the sky, and the like, and which has been scattered due to fog. Here, the environmental light is calculated with use of the method of a conventional art. Specifically, the correction unit 302 extracts a region including pixel values whose magnitudes rank in the top 0.1% in a dark channel image, and calculates environmental light A from an average luminance value of the linear image I′ with respect to the extracted region. Then, the correction unit 302 generates a dark channel image D with use of the following formula (2).

$$D ( x , y ) = {min}_{c ∈ \{ r , g , b \}} ( {min}_{x , y ∈ Ω ( h , v )} ( \frac{{I}^{′} ( x , y , c}{A ( c )} ) ) \qquad ( 2 )$$

Here, Ω(h, v) is a quadrilateral local region for dark channel calculation, and h and v respectively denote ranges of the local region in a horizontal direction and a vertical direction. In one or more embodiments, as an example, the correction unit 302 calculates the minimum values of R, G, B, respectively, for a 3×3 pixel region centered at a target pixel (i.e., h=3, v=3), and replaces the luminance values of R, G, B of the target pixel with the minimum value of R, the minimum value of G, and the minimum value of B, respectively. Then, the correction unit 302 converts the dark channel image D into a transmittance distribution T in accordance with the following formula (3):

$$T ( x , y ) = 1.0 - ω \cdot D ( x , y ) \qquad ( 3 )$$

Here, ω is a parameter for controlling an excessive increase in the transmittance of a subject at a long distance of 0 to 1.0, and a larger effect may be set using ω with a larger value. Here, the quadrilateral shape during the dark channel calculation remains in the transmittance distribution T that has been converted using formula (3). Therefore, it is necessary to reduce this quadrilateral shape. The correction unit 302 calculates a reduced transmittance distribution T′ by applying a Laplacian filter to the transmittance distribution T as in a conventional art. Then, the correction unit 302 performs computation according to the following formula (4) with use of the linear image I′, the environmental light A, and the transmittance distribution T′, thereby generating an image J from which fog has been removed:

$$J ( x , y , c ) = \frac{{I}^{′} ( x , y , c ) - A ( c )}{min ( {t}_{min} , {T}^{′} ( x , y ) )} + A ( c ) \qquad ( 4 )$$

Here, tₘᵢₙ is a coefficient for preventing division by zero; in one or more embodiments, it is assumed that tₘᵢₙ=0.1 as an example. Then, the correction unit 302 generates an output image O by performing gamma correction for output on the image J from which fog has been removed.

As described above, in one or more embodiments, the contrast correction processing according to the tone curve correction processing (fog removal processing) is executed under a condition where there is a high possibility that distances to subjects are constant as a result of determination processing that is in line with a focal length and a distance to a focus position during the shooting. As a result, the contrast correction processing may be switched without executing scene analysis, such as estimation of distances to subjects.

### Configuration(s) of One or More Additional Embodiments

In each of the following one or more additional embodiments, the differences from the aforementioned one or more embodiments will be described, and it is assumed that these one or more additional embodiments are similar to the aforementioned one or more embodiments unless specifically stated otherwise below. In one or more additional embodiments, whether to execute the tone curve correction processing or to execute the correction processing according to the DCP method as the contrast correction processing for a shot image is determined in accordance with “whether an operation mode of the camera 101 is set to a mode for tracking a subject (a tracking mode)”.

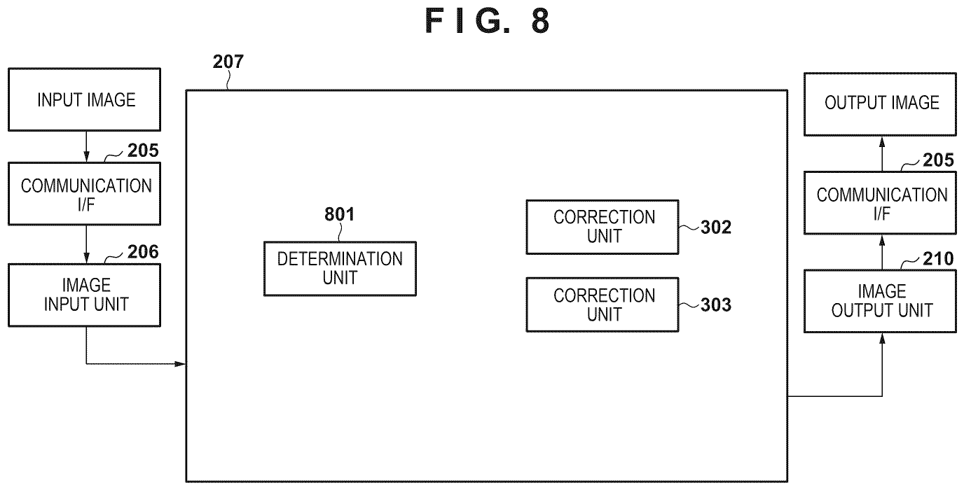

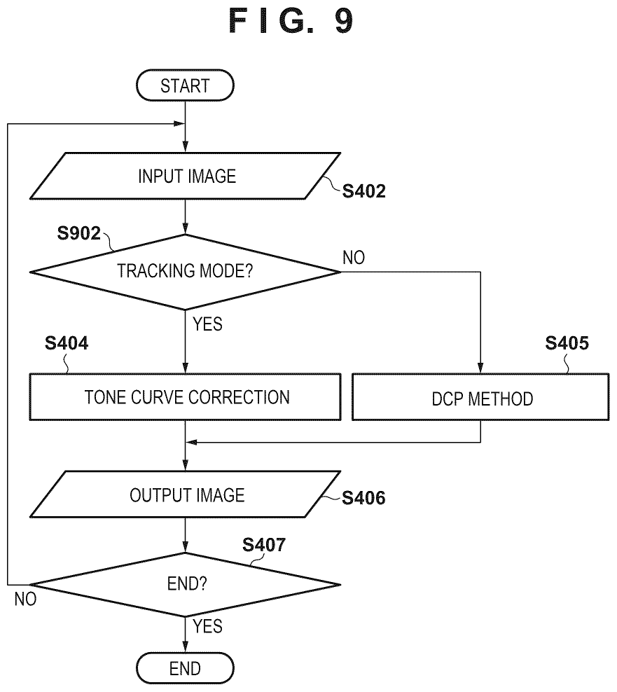

Processing that is executed by the image processing apparatus 100 to correct a decrease in contrast in a shot image shot by the camera 101 (a decrease in contrast in the shot image caused by minute particles in the atmosphere) and output the result of the correction will be described in accordance with at least the embodiment of a flowchart of FIG. 9. Also, at least one additional embodiment of a functional configuration of the image processing unit 207 is shown in a block diagram of FIG. 8.

In step S902, a determination unit 801 (or one or more processors) in the image processing unit 207 determines whether the operation mode, which is a parameter of the camera 101, is set to the tracking mode. Various methods are conceivable as a method of this determination. The following describes an example of a method of this determination.

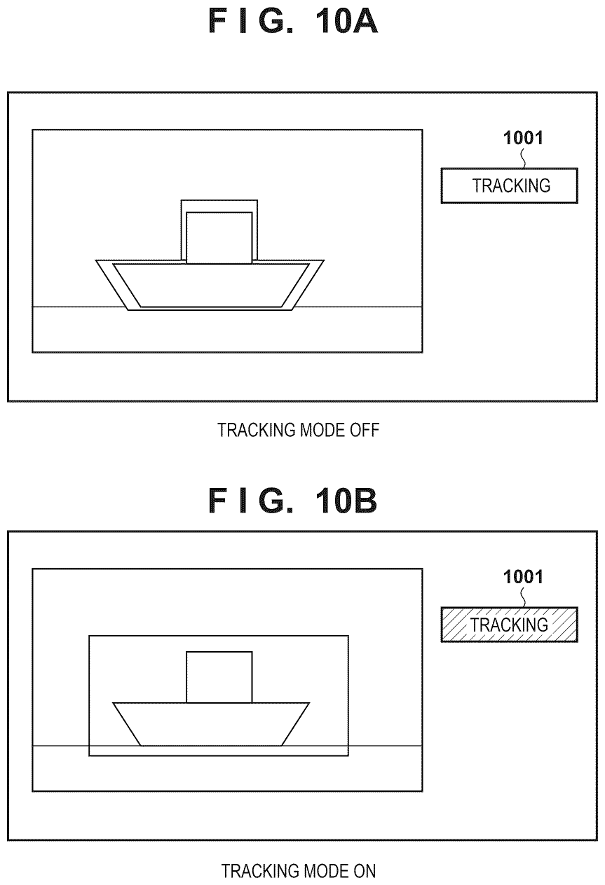

For example, the CPU 201 displays a GUI exemplarily shown in FIG. 10A on the display apparatus 104. Control on display of the GUI is performed by the CPU 201. A button 1001 is a button for selecting setting or cancellation of the tracking mode; in FIG. 10A, the button 1001 indicates a state where the tracking mode has been cancelled (OFF state).

When a user has issued an instruction on the button 1001 on the GUI of FIG. 10A by operating the operation unit 209, the display color of the button 1001 changes as shown in FIG. 10B, and in addition, the CPU 201 sets the operation mode of the camera 101 to the tracking mode. In FIG. 10B, the button 1001 indicates a state where the tracking mode has been set (ON state). The camera 101 in which the tracking mode has been set operates so as to track a subject.

Note that when the user has issued an instruction on the button 1001 on the GUI of FIG. 10B by operating the operation unit 209, the display color of the button 1001 changes as shown in FIG. 10A, and in addition, the CPU 201 sets the operation mode of the camera 101 to another mode (e.g., a normal operation mode) from the tracking mode. The camera 101 in which another mode has been set performs operations corresponding to this another mode.

Therefore, when the button 1001 is in the ON state, the determination unit 801 determines that the operation mode of the camera 101 is set to the tracking mode, and processing proceeds to step S404. On the other hand, when the button 1001 is in the OFF state, it is determined that the operation mode of the camera 101 is not the tracking mode, and processing proceeds to step S405.

In step S407 according to one or more additional embodiments, the control unit 208 determines whether the condition for ending processing according to the flowchart of FIG. 4 has been satisfied; in a case where it has been determined that the ending condition has been satisfied, processing according to the flowchart of FIG. 9 is ended. On the other hand, in a case where it has been determined that the ending condition has not been satisfied, processing proceeds to step S402.

Here, tracking of a subject is a state where the camera is following a subject that is a surveillance target; in general, it is often the case that a subject to be followed is at an equal distance, and therefore fog removal according to the tone curve correction processing is sufficient in a case where the tracking mode has been set.

As described above, according to one or more additional embodiments, in a case where a subject that is a surveillance target has been tracked, a distance to the subject is determined to be a uniform distance, and the tone curve correction processing is applied as the contrast correction processing for a shot image. In this way, processing may be switched without performing scene estimation, such as distance estimation.

### Configuration(s) of One or More Further Embodiments

In one or more further embodiments, detection processing for detecting a subject that is a surveillance target, such as a person and a boat, is executed on an output image that is obtained by executing the correction processing according to the DCP method on an input image. Then, in a case where the subject has been detected from the output image through the detection processing, the tone curve correction processing is executed only on an image region of the detected subject.

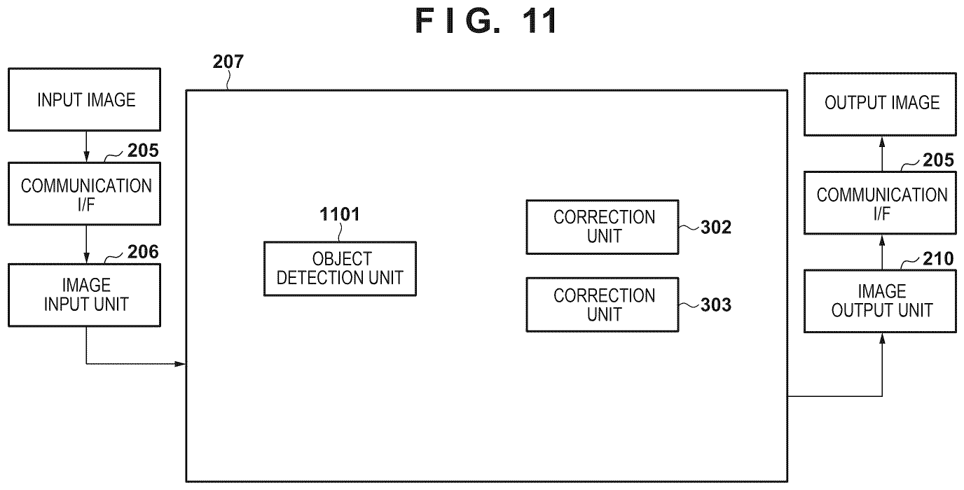

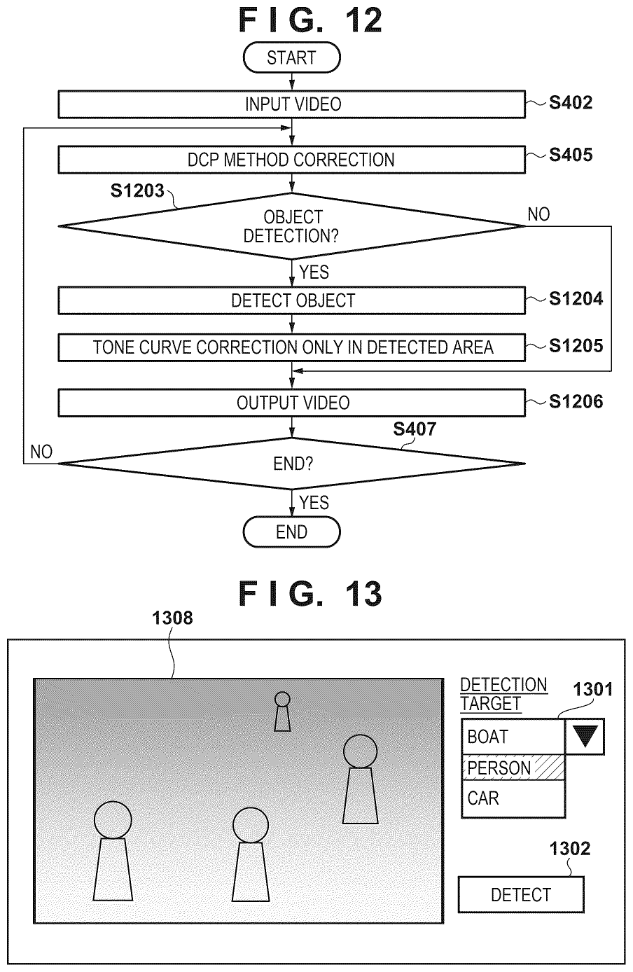

Processing that is executed by the image processing apparatus 100 to correct a decrease in contrast in a shot image shot by the camera 101 (a decrease in contrast in the shot image caused by minute particles in the atmosphere) and output the result of the correction will be described in accordance with at least one embodiment of a flowchart of FIG. 12. Also, at least one further embodiment of a functional configuration of the image processing unit 207 is shown in a block diagram of FIG. 11.

In step S1203, an object detection unit 1101 (or one or more processors) in the image processing unit 207 determines whether an instruction for detecting objects has been issued with respect to the output image O generated in step S405. A method of such determination is not limited to a specific method. The following describes an example of a method of determination in step S1203.

Under control of the CPU 201, a GUI exemplarily shown in FIG. 13 is displayed on the display apparatus 104. On the GUI of FIG. 13, the output image O 1308 generated in step S405 is displayed. When a user has issued an instruction on a list 1301 by operating the operation unit 209 on the GUI of FIG. 13, the CPU 201 displays a list of names of objects that are candidates for detection targets as shown in FIG. 13. When the user has selected one of the names displayed in this list and then issued an instruction on a button 1302 by operating the operation unit 209, the CPU 201 sets objects of the selected name as detection targets.

In this case, when detection target subjects have been set via the GUI of FIG. 13, the object detection unit 1101 determines that “an instruction for detecting objects in the output image O generated in step S405 has been issued”.

On the other hand, when detection target subjects have not been set via the GUI of FIG. 13, the object detection unit 1101 determines that “an instruction for detecting objects in the output image O generated in step S405 has not been issued”.

In a case where it has been determined that “the instruction for detecting objects in the output image O generated in step S405 has been issued” as a result of this determination, processing proceeds to step S1204. On the other hand, in a case where it has been determined that “the instruction for detecting objects in the output image O generated in step S405 has not been issued” as a result of this determination, processing proceeds to step S1206.

In step S1204, the object detection unit 1101 executes subject detection processing for detecting subjects that have been designated as the detection target subjects from the output image O generated in step S405. Various methods may be applied as a method for detecting subjects from an image; for example, subject detection that uses deep learning, such as YOLO, may be applied.

In step S1205, the correction unit 303 in the image processing unit 207 generates an output image O′ obtained by executing, in the output image O generated in step S405, the tone curve correction processing only on the image regions of the subjects detected in step S1204.

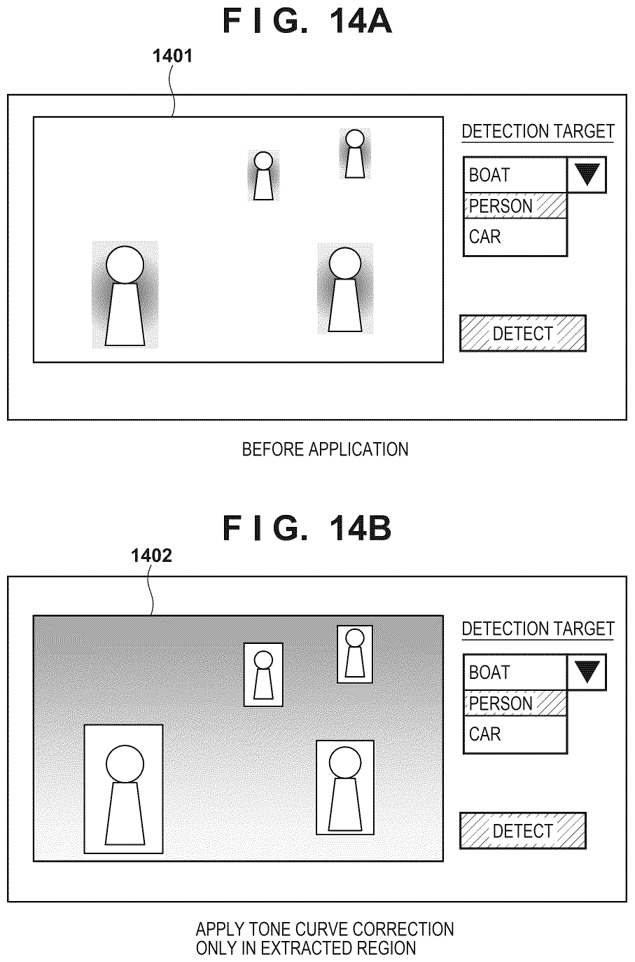

A GUI before processing of step S1205 is shown in FIG. 14A. Also, a GUI after processing of step S1205 is shown in FIG. 14B. As shown in FIG. 14A, halos remain for subjects that have been detected from the output image O 1401 displayed on the GUI before processing of step S1205. If the tone curve correction processing is applied only to the image regions of these detected subjects, fog is not removed in a region other than the image regions of the detected subjects, but halos do not occur and fog has been removed in the image regions of the detected subjects, as shown in the output image O′ 1402 of FIG. 14B.

In step S1206, the image output unit 210 outputs the output image O generated in step S405 or the output image O′ generated in step S1205 to the display apparatus 104 via the communication I/F 205 and the video transmission cable 103.

In step S407 according to one or more further embodiments, the control unit 208 determines whether a condition for ending processing according to the flowchart of FIG. 12 has been satisfied; in a case where it has been determined that the ending condition has been satisfied, processing according to the flowchart of FIG. 12 is ended. On the other hand, in a case where it has been determined that the ending condition has not been satisfied, processing proceeds to step S405.

As described above, according to one or more further embodiments, it is assumed that subject distances are constant in regions of detected subjects, and the tone curve correction processing is applied to these regions. As a result, regarding the detected subjects, visibility may be improved without the occurrence of halos.

### Configuration(s) of One or More Other Embodiments

Although the above embodiments have been described in relation to a case where the camera 101 and the image processing apparatus 100 are separate apparatuses, it is possible to configure the camera 101 that realizes the above-described functions of the image processing apparatus 100 by incorporating the image processing apparatus 100 in the camera 101.

Furthermore, although the above embodiments have been described in relation to a case where the image processing apparatus 100 obtains lens information from the camera 101, a method of obtaining the lens information is not limited to a specific obtainment method. For example, the image processing apparatus 100 may estimate lens information from a shot image obtained from the camera 101 with use of a model that has been trained to estimate lens information from a shot image.

Furthermore, in the aforementioned one or more additional embodiments, the correction processing according to the DCP method is applied first, and then it is switched to the tone curve correction upon entering a tracking state; however, in a case where tracking has been performed from the beginning, the tone curve correction may be applied, and it may be switched to the DCP method upon cancellation of tracking.

The numerical values, processing timings, the order of processing, the main executor of processing, the configuration/obtainment method/transmission destination/transmission source/storage location of data (information), and the like that have been used in the above-described embodiments are presented as examples to provide a specific description, and they are not intended to be limited to such examples.

Also, parts or all of the above-described embodiments may be used in combination as appropriate. Furthermore, parts or all of the above-described embodiments may be selectively used.

### One or More Features or Configurations of Additional, Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-004334, filed Jan. 10, 2025, which is hereby incorporated by reference herein in its entirety.

What is claimed is:

1. An image processing apparatus comprising:
one or more processors that operate to:
determine, based on a parameter of a shooting apparatus that shot a shot image, which one of a first correction processing and a second correction processing is to be executed as a correction processing for correcting a decrease in a contrast in the shot image caused by minute particles in an atmosphere, the first correction processing including performing different contrast correction for each local region of the shot image, and the second correction processing including performing a contrast correction through a tone curve correction; and
execute the determined one of the first correction processing and the second correction processing.

2. The image processing apparatus according to claim 1, wherein the one or more processors further operate to:
determine which one of the first correction processing and the second correction processing is to be executed based on a focal length in shooting of the shot image, and on a distance to a focus position in shooting of the shot image.

3. The image processing apparatus according to claim 1, wherein the one or more processors further operate to:
determine which one of the first correction processing and the second correction processing is to be executed based on whether an operation mode of the shooting apparatus is set to a mode for tracking a subject.

4. The image processing apparatus according to claim 1, wherein
the first correction processing is correction processing according to a Dark Channel Prior (DCP) method.

5. The image processing apparatus according to claim 1, wherein the one or more processors further operate to:
obtain the shot image shot by the shooting apparatus.

6. The image processing apparatus according to claim 1, further comprising
a camera or the shooting apparatus that operates to shoot the shot image.

7. An image processing apparatus comprising:
one or more processors that operate to:
perform different contrast correction for each local region of a shot image as a correction processing for correcting a decrease in a contrast in the shot image caused by minute particles in an atmosphere; and
in a case where a subject is detected in the shot image on which the one or more processors executed contrast correction processing, perform a contrast correction through a tone curve correction on an image region of the subject.

8. An image processing method executed by an image processing apparatus, the image processing method comprising:
determining, based on a parameter of a shooting apparatus that shot a shot image, which one of a first correction processing and a second correction processing is to be executed as a correction processing for correcting a decrease in a contrast in the shot image caused by minute particles in an atmosphere, the first correction processing including performing different contrast correction for each local region of the shot image, and the second correction processing including performing a contrast correction through a tone curve correction; and
executing one of the first correction processing and the second correction processing in accordance with a result of the determination.

9. An image processing method executed by an image processing apparatus, the image processing method comprising:
performing different contrast correction for each local region of a shot image as a correction processing for correcting a decrease in a contrast in the shot image caused by minute particles in an atmosphere; and
in a case where a subject is detected in the shot image on which contrast correction processing was executed, performing a contrast correction through a tone curve correction on an image region of the subject.

10. A non-transitory computer-readable storage medium storing a computer program for causing a computer to perform an image processing method, the method comprising:
determining, based on a parameter of a shooting apparatus that shot a shot image, which one of a first correction processing and a second correction processing is to be executed as a correction processing for correcting a decrease in a contrast in the shot image caused by minute particles in an atmosphere, the first correction processing including performing different contrast correction for each local region of the shot image, and the second correction processing including performing a contrast correction through a tone curve correction; and
executing one of the first correction processing and the second correction processing in accordance with a result of the determination.

11. A non-transitory computer-readable storage medium storing a computer program for causing a computer to perform an image processing method, the method comprising:
performing different contrast correction for each local region of a shot image as a correction processing for correcting a decrease in a contrast in the shot image caused by minute particles in an atmosphere; and
in a case where a subject is detected in the shot image on which contrast correction processing was executed, performing a contrast correction through a tone curve correction on an image region of the subject.
